(19) United States
(12) Patent Application Publication
(10) Pub. No.: US 2021/0392898 A1
(43) Pub. Date: Dec. 23, 2021

(54) STABILIZED HYPOCHLOROUS ACID SOLUTION AND METHOD FOR STABILIZING HYPOCHLOROUS ACID FOR LONGER SHELF LIFE

(71) Applicant: Parasol Medical, LLC, Buffalo Grove, IL (US)

(72) Inventors: Patrick E. Eddy, Allendale, MI (US); Michael D. Kilcran, Antioch, IL (US)

(73) Assignee: Parasol Medical, LLC, Buffalo Grove, IL (US)

(21) Appl. No.: 17/304,494

(22) Filed: Jun. 22, 2021

Related U.S. Application Data
(60) Provisional application No. 62/705,320, filed on Jun. 22, 2020.

(51) Int. Cl. A01N 59/00; A01N 25/02; A01N 25/22; A01N 55/00

(52) U.S. Cl. CPC A01N 59/00; A01N 55/00; A01N 25/22; A01N 25/02

(57) ABSTRACT

A disinfecting solution is provided including hypochlorous acid and chlorine stabilizer. The hypochlorous acid can exist in the solution at a concentration of 0.1 to 1000 ppm. The chlorine stabilizer may be 0.1 to 50 percent by weight of the solution. The chlorine stabilizer may be cyanuric acid.

### BACKGROUND OF THE DISCLOSURE

The present invention generally relates to a solution containing hypochlorous acid (HOCl), and more particularly relates to a solution containing HOCl used as a disinfectant and a method of making the same.

The electrolysis of an aqueous solution of sodium chloride (sometimes referred to as a brine solution) generates HOCl. More specifically, an electrolytic cell typically with a membrane permeable to sodium and chloride ions separates an anode from a cathode. At the anode, an acidic solution of hypochlorous acid, hydrochloric acid (HCl), and the hypochlorite ion (ClO⁻), is produced, as is oxygen (O₂) and chlorine (Cl₂) gases. The chlorine components are in equilibrium, and the dominant chemical is a function of pH, with hypochlorous acid being dominant at pH values between 2 and 7. At the cathode, a basic solution of sodium hydroxide (NaOH) is produced, as well as hydrogen (H₂) gas. The acidic solution generated at the anode is sometimes referred to as the “anolyte” or “acidic electrolyzed water.” The basic solution generated at the cathode is sometimes referred to as the “catholyte” or “basic electrolyzed water.” The combination of the two is sometimes referred to as “neutral electrolyzed water.”

Hypochlorous acid has been used as a sanitizing agent, disinfecting agent, and an antimicrobial agent in various applications. Example applications for hypochlorous acid include disinfecting food processing surfaces and sanitizing medical equipment in hospitals. Hypochlorous acid very rapidly kills microorganisms by irreversibly reacting with membrane enzymes and structural proteins. The “catholyte,” containing sodium hydroxide, has been utilized as a cleaning agent.

However, the “anolyte” has a limited shelf-life with concentration of hypochlorous acid decreasing quickly as a function of time.

### BRIEF SUMMARY OF THE DISCLOSURE

The present disclosure solves that problem by combining a chlorine stabilizer with the hypochlorous acid. The chlorine stabilizer component may be cyanuric acid (CYA).

According to a first aspect of the present disclosure, a disinfecting solution comprises:

hypochlorous acid; and chlorine stabilizer. In embodiments, the disinfectant solution further comprises isopropyl alcohol. In embodiments, the disinfectant solution further comprises: a catholyte product of the electrolysis of the aqueous solution of sodium chloride, the catholyte product comprising the sodium hydroxide. In embodiments, the disinfectant solution further comprises: an anolyte product of the electrolysis of the aqueous solution of sodium chloride, the anolyte product comprising hypochlorous acid.

According to a second aspect of the present disclosure, a disinfecting and antimicrobial solution comprises hypochlorous acid; chlorine stabilizer; and a silane quaternary ammonium ion or salt thereof. In embodiments, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, and 3-(trihydroxysilyl)propyldimethyloctadecyl ammonium chloride.

According to a second aspect of the present disclosure, a method is provided for stabilizing hypochlorous acid comprising adding a chlorine stabilizer to the hypochlorous acid.

These and other features, advantages, and objects of the present disclosure will be further understood and appreciated by those skilled in the art by reference to the following specification, claims, and appended drawings.

### DETAILED DESCRIPTION

For purposes of description herein, it is to be understood that the specific solutions described in the following specification are simply exemplary embodiments of the inventive concepts defined in the appended claims. Hence, physical characteristics and parameters relating to the embodiments disclosed herein are not to be considered as limiting, unless the claims expressly state otherwise.

Described herein is a disinfecting solution as well as a disinfecting and antimicrobial solution. The disinfecting solution includes hypochlorous acid and chlorine stabilizer. The disinfecting and antimicrobial solution includes hypochlorous acid, chlorine stabilizer, and silane quaternary ammonium ion or salt thereof.

In some embodiments, the hypochlorous acid is the product of electrolysis of an aqueous solution of sodium chloride. The hypochlorous acid exists in the solution at a concentration of 0.1 to 1000 ppm, such as a concentration of 0.1 to 200 ppm, or a concentration of 200 to 1000 ppm.

The chlorine stabilizer may be cyanuric acid or any other known pool stabilizer. The chlorine stabilizer may be between 0.1 to 50 percent by weight of the solution.

In some embodiments, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, and 3-(trihydroxysilyl)propyldimethyloctadecyl ammonium chloride. In embodiments, the silane quaternary ammonium ion or salt thereof is 0.1 to 10 percent by weight of the solution, such as 0.75 to 5 percent by weight of the solution, such as 1.9 to 2.1 percent by weight of the solution.

In some embodiments, the disinfecting and antimicrobial solution may further include isopropyl alcohol and/or water.

In some embodiments, the hypochlorous acid is a component of the anolyte of the electrolysis of an aqueous solution of sodium chloride. In such embodiments, the anolyte containing the hypochlorous acid is combined with a solution containing the silane quaternary ammonium ion or salt thereof. In a variation, the catholyte product of the electrolysis of the aqueous solution of sodium chloride is also added to the disinfecting and antimicrobial solution, thus supplying the aqueous solution with sodium hydroxide.

The addition of the chlorine stabilizer prevents the breakdown of the hypochlorous acid, particularly due to ultraviolet light. Thus, the shelf life of the hypochlorous acid will be significantly improved.

The addition of the silane quaternary ammonium ion or salt thereof provides long lasting antimicrobial activity that survives after the expiration of hypochlorous acid due to reaction or otherwise. The silane group of the silane quaternary ammonium ion bonds to the surface to which it is applied. When a microbial cell contacts the silane quaternary ammonium ion, it is thought that several mechanisms cause the death of the microbial cell—(1) the quaternary group causes an ionic imbalance in the cell; or (2) the long alkyl chain penetrates into and ruptures the cell. Unlike hypochlorous acid, the silane quaternary ammonium ion destroys the microbe cell without consuming the silane quaternary ammonium ion. The silane quaternary ammonium ion is free to destroy more microbial cells. Therefore, even after the hypochlorous acid has reacted, the silane quaternary ammonium ion remains bonded to the surface to which it was applied to continue to provide antimicrobial properties. Thus, the addition of silane quaternary ammonium ion or salt thereof provides these additional advantages. The addition of silane quaternary ammonium ion or salt thereof to hypochlorous acid is disclosed in U.S. Patent Application Publication No. US 2021/0137120 A1, entitled “SANITIZING AND ANTIMICROBIAL SOLUTION WITH BOTH SILANE QUATERNARY AMMONIUM WITH HYPOCHLOROUS ACID,” filed on Nov. 11, 2019 on behalf of Patrick E. Eddy et al., the entire disclosure of which is incorporated herein by reference.

In another aspect of this disclosure, an antimicrobial solution comprises sodium hydroxide, silane quaternary ammonium ion or salt thereof, and water. The silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, and 3-(trihydroxysilyl)propyldimethyloctadecyl ammonium chloride. The silane quaternary ammonium ion or salt thereof is 0.1 to 10 percent by weight of the solution.

In embodiments, the sodium hydroxide is a component of a catholyte product of the electrolysis of the aqueous solution of sodium chloride, and the catholyte product is combined with the silane quaternary ammonium ion or salt thereof. In embodiments, the antimicrobial solution further includes an anolyte product of the electrolysis of the aqueous solution of sodium chloride, and the anolyte product comprises hypochlorous acid.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A disinfecting solution comprising:
hypochlorous acid; and
chlorine stabilizer.

2. The disinfecting solution of claim 1, wherein the chlorine stabilizer is 0.1 to 50 percent by weight of the solution.

3. The disinfecting solution of claim 1, wherein the chlorine stabilizer is cyanuric acid.

4. The disinfecting solution of claim 1, wherein the hypochlorous acid exists in the solution at a concentration of 0.1 to 1000 ppm.

5. The disinfecting solution of claim 1, wherein the hypochlorous acid exists in the solution at a concentration of 0.1 to 200 ppm.

6. The disinfecting solution of claim 1, wherein the hypochlorous acid exists in the solution at a concentration of 200 to 1000 ppm.

7. The disinfecting solution of claim 1 and further comprising silane quaternary ammonium ion or salt thereof.

8. The disinfecting solution of claim 7, wherein the silane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

9. The disinfecting solution of claim 7, wherein the silane quaternary ammonium ion or salt thereof is 0.1 to 10 percent by weight of the solution.

10. A disinfecting solution comprising:
hypochlorous acid;
chlorine stabilizer; and
silane quaternary ammonium ion or salt thereof.

11. The disinfecting solution of claim 10, wherein the chlorine stabilizer is cyanuric acid.

12. The disinfecting solution of claim 10, wherein the silane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

13. The disinfecting solution of claim 10, wherein the silane quaternary ammonium ion or salt thereof is 0.1 to 10 percent by weight of the solution.

14. A method of stabilizing hypochlorous acid comprising adding a chlorine stabilizer to the hypochlorous acid.

15. The method of claim 14, wherein the chlorine stabilizer is cyanuric acid.

15. The method of claim 14, wherein the chlorine stabilizer is 0.1 to 50 percent by weight of the solution.

16. The method of claim 14, wherein the hypochlorous acid exists in the solution at a concentration of 0.1 to 1000 ppm.

17. The method of claim 14, wherein the hypochlorous acid exists in the solution at a concentration of 0.1 to 200 ppm.

18. The method of claim 14, wherein the hypochlorous acid exists in the solution at a concentration of 200 to 1000 ppm.
